(19) United States
(12) Patent Application Publication
(10) Pub. No.: US 2001/0012721 A1
(43) Pub. Date: Aug. 9, 2001

(54) PRESS-CONNECTING CONNECTOR

(76) Inventor: KENTARO NAGAI, SHIZUOKA (JP)

Correspondence Address: SUGHRUE MION ZINN MACPEAK AND SEAS, 2100 PENNSYLVANIA AVENUE NW, WASHINGTON, DC, 20037

(21) Appl. No.: 09/326,698

(22) Filed: Jun. 7, 1999

(30) Foreign Application Priority Data
Jun. 9, 1998 (JP) HEI. 10-161031

(51) Int. Cl. H01R 4/24

(52) U.S. Cl. 439/404

(57) ABSTRACT

Terminal receiving chambers (25) for receiving press-connecting terminals (27) are provided respectively on opposite (upper and lower) sides of a partition wall (24) of the connector housing (21). The connector housing has openings (28) through which wires can be press-connected respectively to the press-connecting terminals (27) in the terminal receiving chambers (25). The covers (22) are attached to the connector housing (21) to respectively close the openings (28), with the wires press-connected respectively to the press-connecting terminals (27) in the terminal receiving chambers (25). There are provided provisionally-retaining mechanisms (B) each for provisionally retaining the corresponding cover (22) on the connector housing (21), with the wires press-connected respectively to the press-connecting terminals (27) in the terminal receiving chamber (25). This provisionally-retaining mechanism (B) includes provisionally-retaining projections (34), formed on the cover, and provisionally-retaining recesses (36) formed in the connector housing (21), and the provisionally-retaining projections (34) can be retainingly engaged respectively in the provisionally-retaining recesses (36).

### BACKGROUND OF THE INVENTION

1. Field of the Invention

The present invention relates to a press-connecting connector in which wires are press-connected respectively to press-connecting terminals received in terminal receiving chambers in a connector housing, and then an opening in the terminal receiving chamber is closed by a cover.

The present application is based on Japanese Patent Application No. Hei. 10-161031, which is incorporated herein by reference.

2. Description of the Relates Art

FIGS. 6 to 8 show a press-connecting connector of the type described. FIG. 6 is an exploded, perspective view showing a condition before the press-connecting connector is assembled, FIG. 7 is a cross-sectional view of the press-connecting connector in its assembled condition, and FIG. 8 is a perspective view of a press-connecting terminal. In FIGS. 6 and 7, the press-connecting connector 1 comprises a connector housing 2, and a pair of upper and lower covers 3. The connector housing 2 has a partition wall 4 provided centrally of the height thereof. Terminal receiving chambers 5 are provided respectively on opposite (upper and lower) sides of the partition wall 4. Division walls 6 are formed perpendicularly in each of the terminal receiving chambers 5, and are spaced a predetermined distance from one another in a direction of the width of the connector housing. The terminal receiving chamber 5 is divided into a plurality of sections by these division walls 6. The press-connecting terminals 11 are received in these sections, respectively.

Openings 7 are formed respectively in the upper and lower sides of the connector housing 2 at a rear portion thereof, and a rear portion of each terminal receiving chamber 5 is open to the exterior through the corresponding opening 7. Two covers 3 are attached to the connector housing 2 to close the openings 7, respectively. Insertion projections 8 are formed at a front end of each cover 3, and a retaining projection 9 and a retaining groove 10 are provided at a rear end of the cover. The positions of the retaining projection 9 and retaining groove 10 of the upper cover 3 are reverse with respect to the positions of those of the lower cover 3.

As best shown in FIG. 8, the press-connecting terminal 11 includes an electrical connection portion 12, formed at a front end thereof for electrical connection to a mating connector terminal, a wire clamping portion 13, formed at a rear end thereof for clamping a wire W through an insulating sheath thereof, and a wire press-connecting portion 14 provided between the two portions 12 and 13 so as to be electrically connected to a conductor of the wire W. The wire press-connecting portion 14 has a pair of press-connecting blades 14a and 14a, and when the wire W is press-fitted into a gap between the pair of press-connecting blades 14a and 14a, these blades 14a and 14a cut the insulating sheath of the wire W, and come into electrical contact with the conductor.

For assembling the press-connecting connector 1 of the above construction, the press-connecting terminals 11 are first set respectively in each terminal receiving chamber 5 in the connector housing 2, and then the wires W are press-connected respectively to the press-connecting terminals 11 through the openings 7. Then, each cover 3 is brought into registry with the corresponding opening 7, and the insertion projections 8 of each cover 3 are inserted into an upper (lower) groove 2a (2b) (see FIG. 7) in the connector housing 2, and the retaining projections 9 of the two covers 3 are retainingly engaged in the retaining grooves 10 of the two covers 3, respectively, thus completing the assembling operation.

In the above press-connecting connector 1, however, when attaching the covers 3 to the connector housing 2, the covers 3 are not restrained relative to the connector housing 2, and these covers are restrained when the assembling operation is completed. Therefore, the assembling operation of this connector can not be suitably effected using an automatic cover-attaching machine. Namely, if even a small external force is applied to the cover 3 before the cover 3 is completely attached to the connector housing, the cover 3 is displaced out of position, and therefore there is encountered, for example, a problem that the insertion projections 8 fail to be inserted into the upper groove 2a in the connector housing 2, as shown in FIG. 9.

Particularly in the press-connecting connector 1 of the type in which the terminal receiving chambers 5 are arranged in two (upper and lower) stages, and the two covers 3 are simultaneously attached to the connector housing, it has been difficult to carry out the operation using the automatic cover-attaching machine.

### SUMMARY OF THE INVENTION

The present invention therefore seeks to solve the above problems, and an object of the present invention is to provide a press-connecting connector in which covers can be attached to a connector housing, using an automatic cover-attaching machine.

According to the first aspect of the present invention, there is provided a press-connecting connector which comprises a connector housing including a terminal receiving chamber for receiving a press-connecting terminal, and an opening through which a wire is press-connected to the press-connecting terminal in the terminal receiving chamber, a cover attached to the connector housing to close the opening, with the wire press-connected to the press-connecting terminal in the terminal receiving chamber, and a provisionally-retaining mechanism disposed between the connector housing and the cover, wherein the cover is provisionally retained on the connector housing by the provisionally-retaining mechanism, with the wire press-connected to the press-connecting terminal in the terminal receiving chamber. In the press-connecting connector, after the wires are press-connected respectively to the press-connecting terminals, the cover can be provisionally retained on the connector housing by the provisionally-retaining mechanism. Therefore, even if a small external force is applied to the cover for some reason, the cover will not be displaced out of position relative to the connector housing, and therefore will be held in the provisionally-retained condition.

According to the second aspect of the present invention, preferably, the terminal receiving chamber is provided on each side of a partition wall of the connector housing, and the cover is provided at the opening of the each terminal receiving chamber. In this press-connecting connector, the effects of the first aspect are achieved, and besides the two covers are provisionally retained by the respective provisionally-retaining mechanisms.

According to the third aspect of the present invention, preferably, the provisionally-retaining mechanism includes provisionally-retaining projections, formed on one of the connector housing and the cover, and provisionally-retaining recesses formed in the other one of the connector housing and the cover, and wherein when the cover is provisionally retained on the connector housing, the provisionally-retaining projections are engaged in the provisionally-retaining recesses, respectively. In this press-connecting connector, the effects of the first aspect are achieved, and besides the cover is provisionally retained, with the provisionally-retaining projections provisionally engaged respectively in the provisionally-retaining recesses, and the cover can be displaced from this provisionally-retained condition to the attached condition. Thus, the cover is provisionally retained throughout the attaching process.

### BRIEF DESCRIPTION OF THE DRAWINGS

FIG. 1(a) is an exploded, perspective view of one preferred embodiment of a press-connecting connector of the present invention;

FIG. 1(b) is an enlarged view showing a provisionally-retaining mechanism used in the press-connecting connector;

FIG. 2 is a cross-sectional view showing a condition in which the press-connecting connector is set in an automatic cover-attaching machine during an assembling operation;

FIG. 3 is a perspective view of the press-connecting connector, showing a condition after wire are press-connected;

FIG. 4 is a perspective view of the press-connecting connector, showing a condition after covers are provisionally retained;

FIG. 5 is a perspective view of the press-connecting connector in its completely-assembled condition;

FIG. 6 is an exploded, perspective view showing a condition before the related press-connecting connector is assembled;

FIG. 7 is a cross-sectional view of the related press-connecting connector in its assembled condition;

FIG. 8 is a perspective view of a press-connecting terminal used in the related press-connecting connector; and

FIG. 9 is a cross-sectional view showing an improperly-assembled condition of the related press-connecting connector.

### DETAILED DESCRIPTION OF THE PREFERRED EMBODIMENT

One preferred embodiment of the present invention will now be described with reference to the drawings.

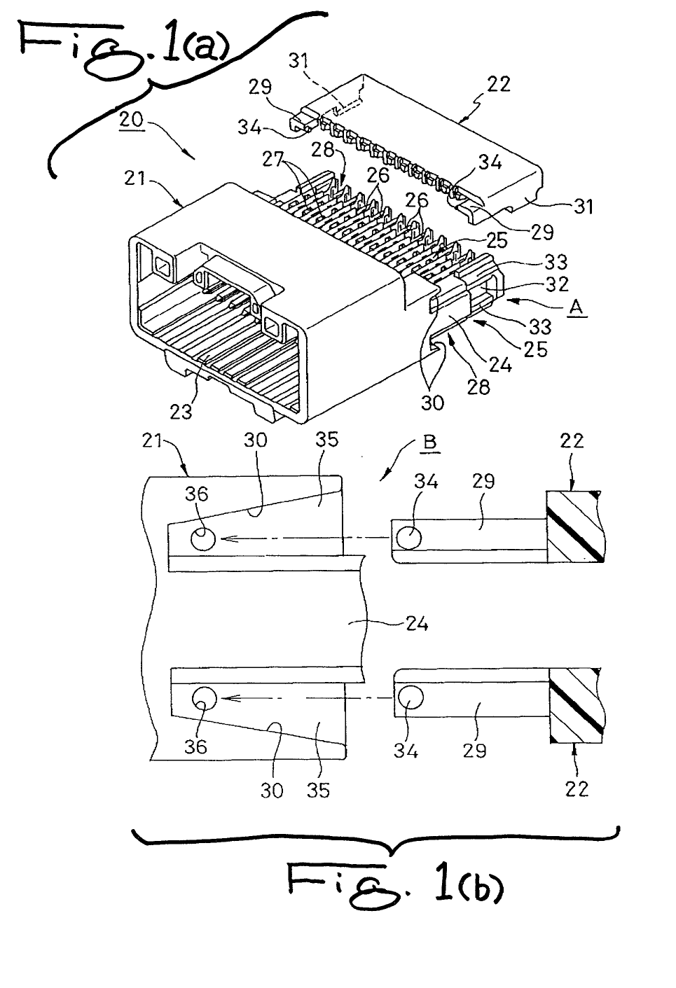

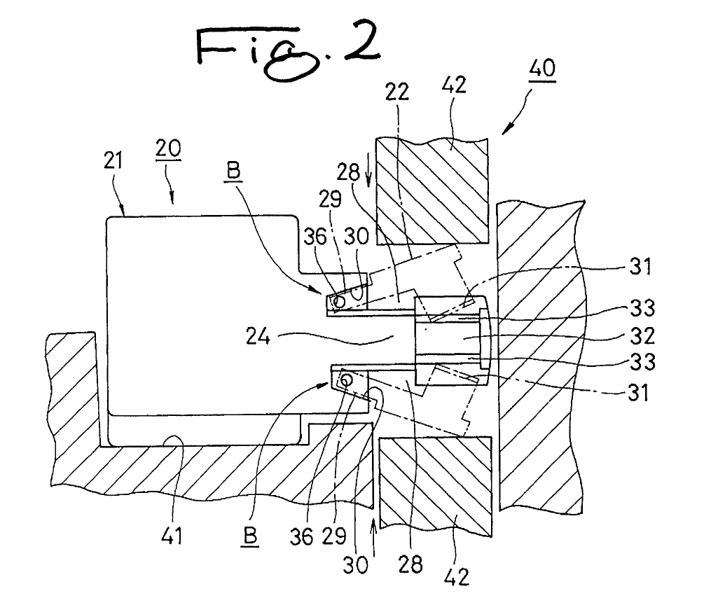

FIG. 1(a) is an exploded, perspective view of one preferred embodiment of a press-connecting connector of the present invention, FIG. 1(b) is an enlarged view showing a provisionally-retaining mechanism, and FIG. 2 is a cross-sectional view showing a condition in which the press-connecting connector is set in an automatic cover-attaching machine during an assembling operation. In FIG. 1(a), the showing of a lower cover is omitted.

In FIGS. 1(a), 1(b) and 2, the press-connecting connector 20 comprises a connector housing 21 made of a synthetic resin, and two covers 22 made of a synthetic resin. A front portion of the connector housing 21 is formed into a hood portion 23 of a generally square box-shape having an open front side, and a mating connector is adapted to be fitted into this hood portion 23. A partition wall 24 is provided at a rear portion of the connector housing 21 to divide this rear portion into upper and lower portions. Terminal receiving chambers 25 are provided respectively on opposite (upper and lower) sides of the partition wall 24. Division walls 26 are formed perpendicularly in each of the terminal receiving chambers 25, and are spaced a predetermined distance from one another in a direction of the width of the connector housing. The terminal receiving chamber 25 is divided into a plurality of sections by these division walls 26. Press-connecting terminals 27 are received in these sections, respectively.

Openings 28 are formed respectively in the upper and lower sides of the connector housing 21 at the rear portion thereof, and the rear portion of each terminal receiving chamber 25 is open to the exterior through the corresponding opening 28. The two covers 22 have such a configuration that they can be attached to the connector housing 21 to close the openings 28, respectively. Each cover 22 and the connector housing 21 have a retaining mechanism A as well as the provisionally-retaining mechanism B.

The retaining mechanism A includes insertion projections 29, formed on and projecting respectively from opposite side portions of a front end of the cover 22, and grooves 30 formed respectively in opposite side portions of a central portion of the connector housing 21. The insertion projections 29 can be inserted into the grooves 30, respectively. The retaining mechanism A further includes retaining projections 31, formed on and projecting downwardly respectively from the opposite side portions of a rear portion of the cover 22, and retaining recesses 32 formed respectively in opposite side surfaces of the partition wall 24 of the connector housing 21. The retaining projections 31 can be retainingly engaged in the retaining recesses 32, respectively. In this embodiment, each of the retaining recesses 32 is designed to retain the associated retaining projections 31 of the two covers 22. Each of upper and lower projected walls 33 of the retaining recess 32 has a slanting surface so as to smoothly bring the associated retaining projection 31 into retaining engagement with the retaining recess 32. Namely, the insertion projections 29 of each cover 22 are inserted respectively into the associated grooves 30 in the connector housing 21, and also the retaining projections 31 of the cover 22 are retainingly engaged respectively in the retaining recesses 32 in the connector housing 21, so that the cover 22 is attached to the connector housing.

The provisionally-retaining mechanism B includes provisionally-retaining projections 34 of a cylindrical shape, formed respectively on opposed surfaces of the insertion projections 29 of the cover 22, and provisionally-retaining recesses (circular holes) 36 formed respectively in inner surfaces 35 of the grooves 30 in the connector housing 21. The provisionally-retaining projections 34 can be inserted into the provisionally-retaining holes 36, respectively. When the pair of provisionally-retaining projections 34 and 34 of the cover 22 are inserted respectively into the provisionally-retaining holes 36 and 36, the cover 22 is held in its provisionally-retained condition, and the cover 22 can be displaced into an attached condition while maintaining this provisionally-retained condition.

The automatic cover-attaching machine 40 comprises a connector positioning portion 41 for positioning the press-connecting connector 20 in the provisionally-retained condition, and a pair of air cylinders (pressing members) 42 and 42 for respectively pressing the two covers 22 from their provisionally-retained condition to the attached condition.

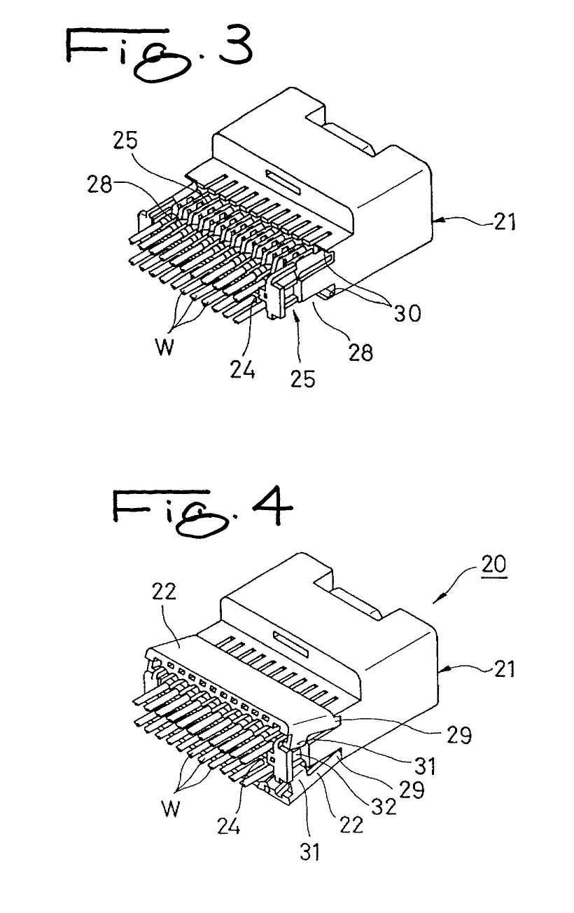

Next, the assembling process of the press-connecting connector 20 will be described with reference to FIGS. 3 to 5. First, the press-connecting terminals 27 are set in the terminal receiving chambers 25 in the connector housing 21, and wire W are press-connected respectively to these press-connecting terminals 27, as shown in FIG. 3.

Then, the provisionally-retaining projections 34 of each cover 22 are inserted respectively into the provisionally-retaining holes 36 in the connector housing 21, so that the two covers 22 are held in the provisionally-retained condition, as shown in FIG. 4.

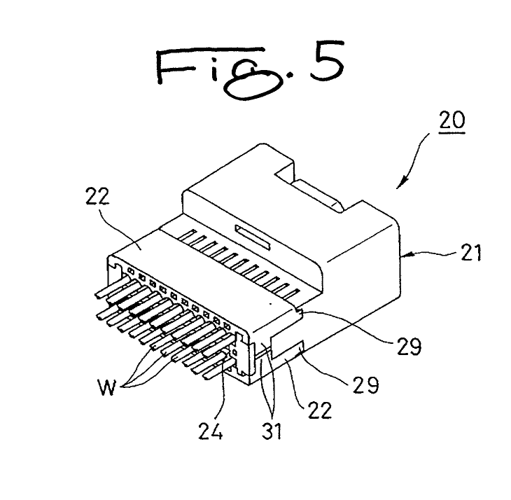

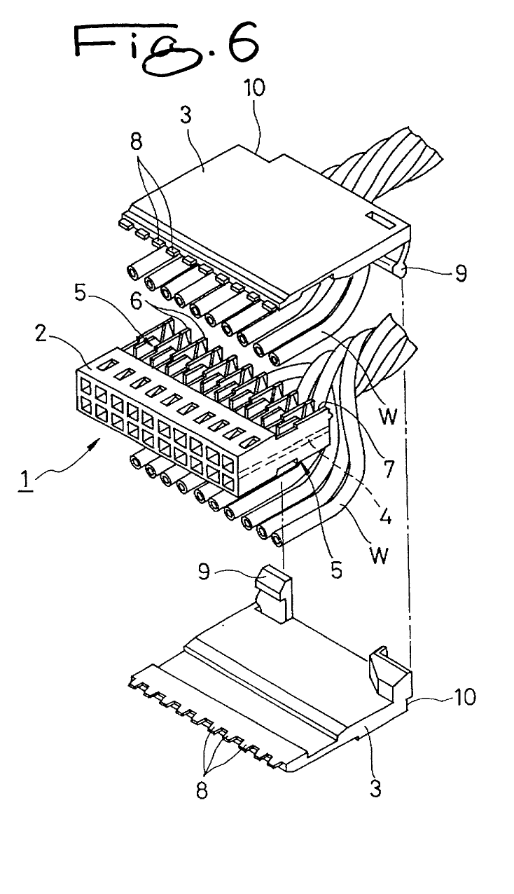

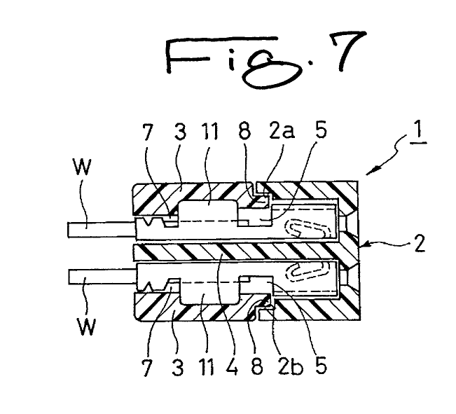

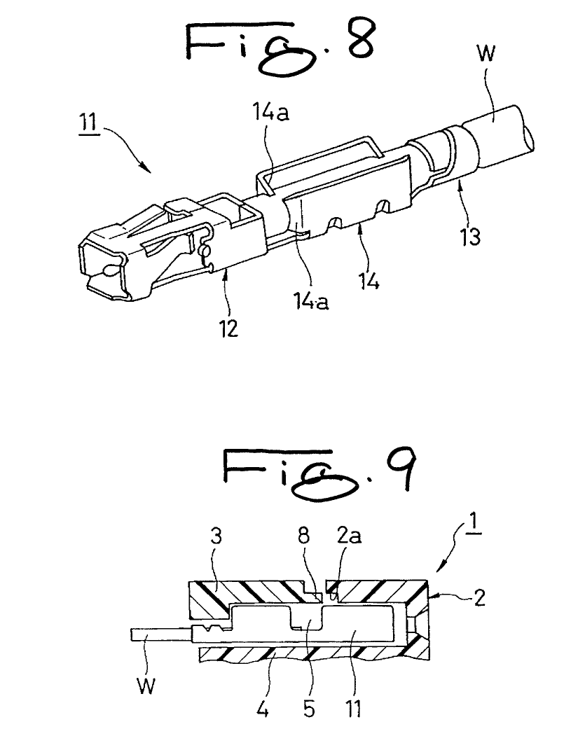

Then, the press-connecting connector 20 in this provisionally-retained condition is set in the automatic cover-attaching machine 40 as shown in FIG. 4. At this time, the pair of air cylinders 42 and 42 are moved toward each other, and press the outer surfaces of the two covers 22, respectively. As a result, each cover 22 is pivotally moved about the provisionally-retaining projection 34, and the retaining projections 31 of each cover 22 are elastically deformed to slide over the associated projected walls 33 to fit respectively into the retaining recesses 32, so that the two covers 22 are simultaneously attached to the connector housing, as shown in FIG. 5, thus completing the assembling operation of the press-connecting connector 20.

In the attaching process of the covers 22, each cover 22 can be provisionally retained on the connector housing 21 by the provisionally-retaining mechanism B, and therefore even if a small external force is applied to the cover 22 for some reason, the cover 22 will not be displaced with respect to the connector housing 21, and therefore will be kept in the provisionally-retained condition. Therefore, the attachment of the covers 22 can be effected by the use of the automatic cover-attaching machine 40. And besides, each cover 22 is provisionally-retained, with the provisionally-retaining projections 34 retainingly engaged respectively in the provisionally-retaining holes 36, and the cover 22 can be displaced into the attached condition while maintaining this provisionally-retaining condition. Therefore, each cover 22 is kept provisionally retained throughout the attaching process, and the attaching operation can be carried out positively. The two covers 22 are provisionally retained by the respective provisionally-retained mechanisms B, and therefore the two covers 22 can be simultaneously attached by the use of the automatic cover-attaching machine 40, and the operation can be carried out rapidly. The covers 22 may be attached one by one.

In the above embodiment, the connector housing 21 has the terminal receiving chambers 25 arranged in two (upper and lower) stages, and these terminal receiving chambers 25 are closed by the two covers 22, respectively. However, the present invention can be applied to a connector having one terminal receiving chamber 25 or more than two terminal receiving chambers. Although the provisionally-retaining mechanism B includes the provisionally-retaining projections 34, formed on the cover 22, and the provisionally-retaining holes (recesses) 36 formed in the connector housing 21, there may be used an arrangement in which the provisionally-retaining holes (recesses) 36 are formed in the cover 22 while the provisionally-retaining projections 34 are formed on the connector housing 21. The provisionally-retaining mechanism B may be of any construction in so far as it can provisionally retain the cover 22 on the connector housing 21.

As described above, in the first aspect of the present invention, there is provided the provisionally-retaining mechanism for provisionally retaining the cover on the connector housing, with the wires press-connected respectively to the press-connecting terminals in the terminal receiving chamber. Therefore, after the wires are press-connected respectively to the press-connecting terminals, the cover can be provisionally retained on the connector housing by the provisionally-retaining mechanism. Therefore, even if a small external force is applied to the cover for some reason, the cover will not be displaced out of position relative to the connector housing, and therefore will be held in the provisionally-retained condition. Therefore, the cover-attaching operation can be carried out easily and positively, using the automatic cover-attaching machine.

In the second aspect of the present invention, the terminal receiving chamber is provided on each side of the partition wall of the connector housing, and the cover is provided at the opening of each of the terminal receiving chambers. Therefore, the effects of the first aspect are achieved, and besides the two covers are provisionally retained by the respective provisionally-retaining mechanisms, and the two covers can be attached simultaneously by the use of the automatic cover-attaching machine, and the operation can be carried out rapidly.

In the third aspect of the present invention, the provisionally-retaining mechanism includes the provisionally-retaining projections, formed on one of the connector housing and the cover, and the provisionally-retaining recesses formed in the other of the connector housing and the cover, and the provisionally-retaining projections can be retainingly engaged -respectively in the provisionally-retaining recesses, and the cover can be displaced from the provisionally-retained condition to the attached condition, with the provisionally-retaining projections retainingly engaged respectively in the provisionally-retaining recesses. Therefore, the effects of the first aspect are achieved, and besides the cover is provisionally retained, with the provisionally-retaining projections provisionally engaged respectively in the provisionally-retaining recesses, and the cover can be displaced from this provisionally-retained condition to the attached condition. Thus, the cover is provisionally retained throughout the attaching process, and therefore can be positively attached to the connector housing.

What is claimed is:

1. A press-connecting connector, comprising:
a connector housing including a terminal receiving chamber for receiving a press-connecting terminal, and an opening through which a wire is press-connected to the press-connecting terminal in the terminal receiving chamber;
a cover attached to the connector housing to close the opening, with the wire press-connected to the press-connecting terminal in the terminal receiving chamber; and
a provisionally-retaining mechanism disposed between the connector housing and the cover, wherein the cover is provisionally retained on the connector housing by the provisionally-retaining mechanism, with the wire press-connected to the press-connecting terminal in the terminal receiving chamber.

2. The press-connecting connector of claim 1, wherein the terminal receiving chamber is provided on each side of a partition wall of the connector housing, and the cover is provided at the opening of the each terminal receiving chamber.

3. The press-connecting connector of claim 1, wherein the provisionally-retaining mechanism includes provisionally-retaining projections, formed on one of the connector housing and the cover, and provisionally-retaining recesses formed in the other one of the connector housing and the cover, and wherein when the cover is provisionally retained on the connector housing, the provisionally-retaining projections are engaged in the provisionally-retaining recesses, respectively.

4. The press-connecting connector of claim 3, wherein the cover can be displaced from a provisionally-retained condition to an attached condition, with the provisionally-retaining projections engaged in the provisionally-retaining recesses, respectively.
